(19) United States
(12) Patent Application Publication
(10) Pub. No.: US 2026/0264879 A1
(43) Pub. Date: Sep. 10, 2026

(54) ADJUSTABLE ECCENTRIC RING

(71) Applicant: SONACA S.A., GOSSELIES (BE)

(72) Inventors: Didier DE PLAEN, Woluwé-Saint-Pierre (BE); Xavier GODFROID, MONT-SAINT-GUIBERT (BE); Dimitri GUEUNING, RIXENSART (BE)

(21) Appl. No.: 18/993,486

(22) PCT Filed: Jul. 4, 2023
(86) PCT No.: PCT/EP2023/068447

§ 371 Date: Jan. 10, 2025

(30) Foreign Application Priority Data
Jul. 12, 2022 (BE) 20225565

(51) Int. Cl. B64F 5/10; B64C 9/02; B64C 9/08

(52) U.S. Cl. CPC B64F 5/10; B64C 9/02; B64C 9/08

(57) ABSTRACT

The present invention relates to an adjustable guide ring comprising a first ring with a first eccentric opening and a second ring with a second eccentric opening, the first ring being housed in the second opening of the second ring.

The invention also relates to a procedure for adjusting an eccentricity of said ring.

### TECHNICAL FIELD AND PRIOR ART

The present invention relates to the field of aircraft wings, of the type comprising a load-bearing central wing body, which remains fixed and which bears one or more movable leading-edge flaps, also referred to as “slats”.

Each of the two wings of the airfoil is generally fitted with movable high-lift flaps, mounted on the leading edge of the wing. The flaps are deployed during the landing and take-off phases in order to increase the lift at low or medium speed. When cruising at high speed, the movable flaps are retracted to limit resistance to the forward movement of the aircraft.

Today, fitting the fixed leading edges and movable flaps to the wing involves a number of operations. The fixed leading edges and movable flaps consist of multiple parts, comprising for example ribs, skins, electrical systems, as well as guide rails, hinges and pivoting arms, to enable the movable part to be given the desired movement. During the assembly of the fixed leading edge and the movable flaps, these different parts are integrated individually into the wing by operations including drilling and riveting to form the fixed leading edge and bolting and adjusting to mount the movable flaps. During this time, other work on the wing cannot be carried out and the assembly line remains blocked. In addition, the drilling operations tend to deposit metal shavings in removable parts of the wing, which are then at risk of getting damaged when they move. Another risk comprises damage to electrical cables during the drilling operations.

Thus, it would be advantageous to configure a leading edge module, comprising the fixed leading edge and the movable flap with its removable parts, which can be mounted on the wing without the need to carry out drilling operations on the assembly line.

### DESCRIPTION OF THE INVENTION

Consequently, one aim of the present invention is to offer an adjustable guide ring comprising a first ring with a first eccentric opening and a second ring with a second eccentric opening. The first ring is housed in the second opening of the second ring.

An eccentricity of the first opening in the first ring can correspond to an eccentricity of the second opening in the second ring and a first securing means for fixing a relative position between the first and the second ring can be provided.

The first ring and the second ring can comprise an indicator for indicating an orientation of the eccentricity of the first ring in the second ring. Advantageously, the indicator comprises a dial on the first and/or on the second ring, the dial comprising symbols for indicating an orientation of the eccentricity of the first ring in the second ring.

The ring can comprise a second securing means for fixing a rotary position of the first and/or of the second ring with respect to an environment receiving the second ring, the second securing means being configured to be able to be secured to the first and/or second ring at one from a plurality of rotary positions. The second securing means can comprise a second dial for indicating said rotary position.

The second securing means can be a plate comprising a first device for being secured to the environment and a crenellated opening for receiving the first ring. The crenellated opening can comprise the second dial, the first ring comprising a crenellated edge configured to be housed in said crenellated opening.

A procedure for adjusting an eccentricity of the ring described previously can comprise the following steps:
providing the eccentricity of the first ring and the eccentricity of the second ring,
providing a distance between centres of a first circular piercing in a first part and a second circular piercing in a second part when said parts are positioned at a required relative position,
determining a rotary position of the first ring with respect to the second ring so that the eccentricity of the adjustable guide ring corresponds to said distance.

Advantageously, the method comprises the step of providing a position to be adjusted on said dial to establish the rotary position of the first ring with respect to the second ring determined.

Advantageously, the method can comprise the following steps:
determining a direction of the distance between centres with respect to a point of securing the second securing means on the first or second part,
determining a rotary position of the second securing means with respect to the first and/or second ring to orient the eccentricity of the guide ring in the direction determined when the second securing means is secured to the securing point, preferably,
providing a position to be adjusted on the second dial to establish said rotary position of the second securing means with respect to the first and/or second ring.

A procedure for securing a leading-edge module on a wing box can comprise the following steps:
providing an adjustable guide ring as described previously,
implementing the method described above in which the first part is the leading-edge module and the second part is the wing box.

### BRIEF DESCRIPTION OF THE DRAWINGS

The present invention will be better understood based on the following description and the appended drawings wherein:

FIG. 1 shows a first part to be secured and a second part to be secured, the two parts being designed to be secured one with respect to the other,

FIG. 2 shows the mechanism of an adjustable guide ring or, in other words, of an eccentric double ring,

FIG. 3 shows the adjustable guide ring mounted in an environment receiving the ring,

FIG. 4 shows a view in cross section the adjustable guide ring mounted in an environment receiving the ring,

FIG. 5 shows a second securing means,

FIG. 6 shows a securing nut with a tab washer or lock washer,

FIG. 7 shows a leading-edge module and a wing box.

### DETAILED DESCRIPTION OF SPECIFIC EMBODIMENTS

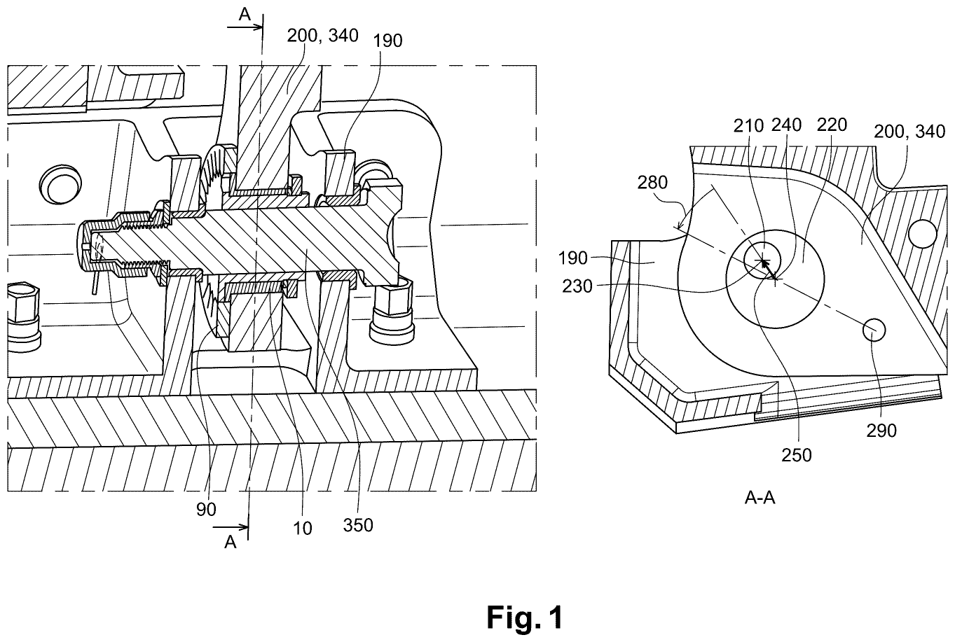

FIG. 1 shows a first part (190) to be secured and a second part (200) to be secured, the two parts being designed to be secured one with respect to the other.

In the example shown, it is a case of a male clevis and a female clevis that are to be mutually secured. The first part to be secured can be a leading-edge module (190) and the second part to be secured can be a wing box (200). Said securing thus mounts the leading-edge module on the wing box. The first part and the second part are secured with respect to each other by a connection bolt (350).

The right-hand part of FIG. 1 shows a section along the line A-A indicated on the left-hand part, but without the connection bolt. The connection bolt (350) is received by a first piercing (210) in the first part and a second piercing (220) in the second part, as shown in FIG. 1, left-hand portion. More precisely, the first and second piercings can be manufactured by boring. The right-hand portion of FIG. 1 shows the first part and the second part held in a required relative position, before the bolt is inserted. It is observed that a diameter of the first piercing is less than a diameter of the second piercing. It is also observed that a centre of the first piercing (230) is moved with respect to a centre of the second piercing (240). Said movement can be characterised by a vector, indicated by an arrow between said centres on FIG. 1, right-hand portion. Said vector has a length corresponding to a distance (250) between the centres of the piercings. An orientation of the vector can be described by an angle (280) relating to a straight line passing through the centre of the second piercing (240) and a securing point (290) on the first or second part, as will be detailed hereinafter. In general terms, said securing point is located on the portion receiving the adjustable ring or eccentric double ring. Said angle thus fixes a direction of the distance between centres with respect to the securing point on the first or on the second part. On FIG. 1, said securing point is provided on the second part.

In summary, the relative positions of the first piercing and of the second piercing are described by a distance between centres of the piercing and by a direction of the distance. The direction of the distance is described by said angle (280).

The connection bolt (350) passes through first piercing and the second piercing to secure together the two parts, as shown in the left-hand portion of FIG. 1. Thus, a diameter of the bolt is smaller than one of the two piercings. As shown in FIG. 1, right-hand portion, the diameter of the bolt must be smaller than the diameter of the second piercing in the second part in the example shown.

The space remaining between the bolt and the piercing in the second part must thus be filled to ensure good holding of the two parts by the bolt. For example, a guide ring can be used. As can be seen in the right-hand portion of FIG. 1, it is necessary to use an eccentric guide ring. An eccentric guide ring comprises an opening placed eccentrically. In other words, a centre of the opening of the ring is moved with respect to the centre of an external circumference of the ring.

The eccentricity and the orientation of the eccentricity of the ring are described by a vector.

An “eccentricity” of the ring is the size or the length of said movement of the centres or the distance of this movement of centres. In other words, it is a case of the length of the connection vector between the two centres.

An “orientation” of this eccentricity is the direction of this movement with respect to a straight line passing through the centre of the external circumference of the ring. Said straight line remains fixed with respect to said external circumference of the ring. In other words, it is a case of the direction of the vector with respect to said straight line.

For the two parts shown in FIG. 1, the eccentricity of the ring to be used must correspond to the distance between centres (250) of the piercings in the parts. As will be described hereinafter, the ring to be used will be an adjustable ring or eccentric double ring. In addition, the ring must be turned with respect to an environment (340) receiving the ring to align the orientation of the eccentricity of the ring with the direction of the distance between the centres (280) of the piercings in the two parts to be secured. In other words, the vector of the distance between centres must be aligned with the vector of the eccentricity of the ring.

In order to be able to provide a ring with an eccentricity adapted to said distance between centres, which may vary according to the manufacturing variables, it would be advantageous to use an adjustable guide ring.

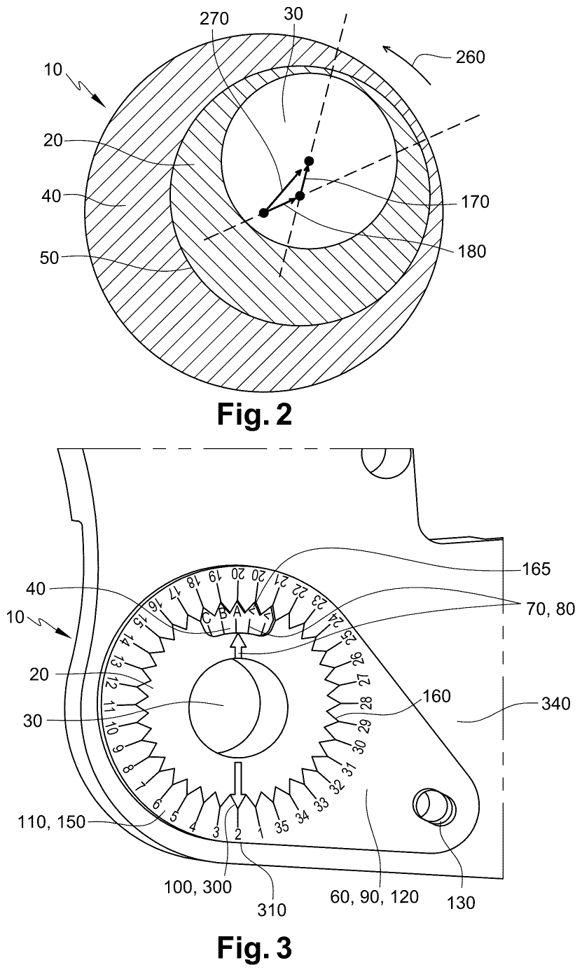

FIG. 2 shows an adjustable guide ring (10). The adjustable guide ring comprises a first ring (20) with a first eccentric opening (30) and a second ring (40) with a second eccentric opening (50). In other words, the first and second ring each have an external circular shape with an external circumference and a circular opening. For each ring, the centre of the circular opening is moved with respect to the centre of the external circular form of the ring. Thus, the first ring has a first eccentricity (170) and the second ring has a second eccentricity (180).

As shown in FIG. 1, first ring is housed in the second opening of the second ring. The adjustable guide ring thus has the external circular form of the second ring and of the second opening of the first ring. Consequently, an eccentricity of the adjustable guide ring (270) corresponds to the movement of the centre of the first opening with respect to the centre of the external circular form of the second ring. As shown in FIG. 2, the eccentricity of the adjustable guide ring (270) is the magnitude of the vector sum of the vector characterising the first eccentricity of the first ring (170) and of the vector characterising the second eccentricity of the second ring (180). The eccentricity of the adjustable guide ring (270) can thus be adjusted by turning the first ring inside the second ring. A rotary position (260) of the first ring with respect to the second ring thus determines a distance or eccentricity of the adjustable guide ring.

By changing the eccentricity of the adjustable guide ring, an orientation its eccentricity changes. The orientation of the eccentricity of the adjustable guide ring can be described with respect to the straight line passing through the centre of the circumference of the second ring and the centre of the circumference of the first ring. In other words, the eccentricity of the adjustable ring is a function of the orientation of the eccentricity.

Knowing the distance between centres (250) of the first and second piercings (230, 240) of the two parts to be secured, the eccentricity of the adjustable guide ring can be adjusted to correspond to said distance by selecting the corresponding rotary position (260) between the first and second rings. Said rotary position, or in other words a rotary position between the two rings, can be described by the angle between the vectors characterising the first eccentricity of the first ring and the second eccentricity of the second ring, as indicated in FIG. 2.

Once the eccentricity of the guide ring is adjusted to a required value, said eccentricity can be fixed by a first securing means (60). Said first securing means is thus configured to fix the rotary position selected between the first and the second ring. It thus fixes the adjusted eccentricity.

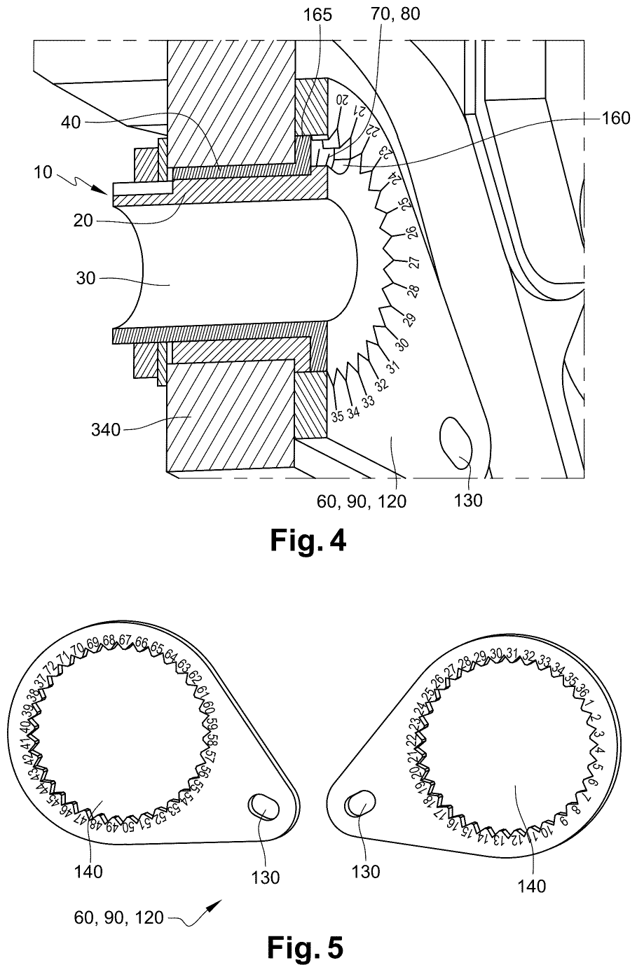

FIG. 4 shows an example of the first securing means. In the example shown, the first ring has a crenellated edge (160). The second ring also has a crenellated edge (165). The first securing means comprises a plate with an opening having inside it a crenellated surface. The crenellated surface of the opening of the first securing means is secured at the same time on the crenellated edge of the first and of the second ring, as shown in FIG. 4. Thus, neither the first ring nor the second ring can turn with respect to the first securing means. A rotary position of the first ring with respect to the second ring is thus fixed.

Advantageously, the eccentricity of the first opening in the first ring corresponds to the eccentricity of the second opening in the second ring. In this case, the eccentricity of the adjustable guide ring can be adjusted between a zero value and a value of twice the eccentricity of the first opening in the first ring.

As described previously, through the rotary position (260) between the two rings, the eccentricity of the adjustable guide ring can be adjusted to correspond to the distance between centres (250) of the first and second piercings (230, 240). It is thus advantageous to provide an indicator (70) for indicating an orientation of the eccentricity of the first ring in the second ring. In other words, the indicator (70) makes visible the orientation of the eccentricity of the first ring with respect to the orientation of the eccentricity of the second ring. Again in other words, the indicator makes visible the rotary position (260) between the orientation of the eccentricity of the first and of the second ring so as to be able to make visible the eccentricity of the adjustable guide ring. Said indicator (70) is included by the first and by the second ring. As the orientation of the eccentricity of the first ring with respect to the orientation of the eccentricity of the second ring determines the vector sum of the eccentricities, this orientation determines the eccentricity of the adjustable ring and the direction of the eccentricity of the adjustable ring. The direction of the eccentricity of the adjustable ring can, as described previously, be defined by the angle between two straight lines: A first straight line passing through the centres of the external circumferences of the first and second ring. A second straight line passing through the centre of the external circumference of the second ring and the centre of the opening of the first ring.

FIG. 3 shows an example of an indicator (70). The indicator comprises a dial (80) on the first and/or on the second ring. In the example shown, the indicator comprises a dial on the second ring. A line or an arrow on the first ring is positioned facing a symbol on the dial. The position indicated by the arrow on the dial can thus be translated into the eccentricity of the adjustable ring.

To secure the first part (190) and the second part (200) by means of the bolt (350) and the adjustable ring (10), the orientation of the eccentricity of the adjustable ring (270) must be orientated with respect to the two parts to correspond to the direction of the distance between centres (250) of the piercings (210, 220). Preferably, it must be secured in this position. In other words, the vector characterising the distance between centres (250) shown in FIG. 1, on the right, must be aligned with the vector characterising the orientation of the eccentricity (270) of the adjustable ring, shown in FIG. 2. The adjustable ring can for this purpose comprise a second securing means (90) for fixing a rotary position of the first and/or of the second ring with respect to an environment (340) receiving the second ring.

In the example shown in FIG. 1, the second securing means (90) secures the first and the second ring with respect to the second part. The second part receives the adjustable guide ring. As shown in FIGS. 3 and 4, the second securing means is configured to be able to be secured to the first and/or to the second ring at one from a plurality of rotary positions (100). The second securing means also comprises a second dial (110) for indicating said rotary position.

The second dial makes it possible to orient the second securing means with respect to the adjustable guide ring. This orientation is selected to align the eccentricity of the ring with the distance between centres (250) shown in FIG. 1, once the second securing means is secured to the environment.

FIGS. 3, 4 and 5 show the second securing means implemented by a plate (120). As described above, this plate is at the same time the first securing means. In the example shown, the first ring and the second ring each comprise a crenellated edge. The plate comprises a crenellated opening that is secured to the two crenellated edges of the first and second ring. As described previously, a rotary position between the first and the second ring is thus fixed. In addition and at the same time, an orientation of the eccentricity of the adjustable ring (270) with respect to the first and second part is also fixed by securing the plate to the first and/or second part. As described previously, it may be a case of a male/female clevis. For example, the crenellated surface can comprise 36 teeth, corresponding to a pitch adjustment of 10°.

Advantageously, the serration or the teeth of the crenellated opening of the plate are offset with respect to the securing device (130) on the plate. In other words, a point of a tooth of the serration is not located on a straight line passing through the securing device and the centre of the crenellated opening of the plate, but is offset with respect to said straight line. For example, an offset angle of 2.5° can be selected. In this case, for a plate comprising 36 teeth, an adjustment pitch of 5° can be obtained by turning over the plate, as shown in FIG. 5.

As shown in FIGS. 3, 4 and 5, the plate comprises a first device (130) for being secured to the environment receiving the second ring, for example to the first and/or the second part. In the example shown, said first device is an opening in the plate. The orientation of this opening in the plate with respect with respect to the adjustable guide ring determines the orientation of the eccentricity of the adjustable ring with respect to the first and the second part and thus also with respect to the direction of the distance between centres (250), shown in FIG. 1. The plate is secured with the first device (130) at the securing point (290) on the first or second part, shown in FIG. 1, on the right.

FIGS. 3 and 4 show that the crenellated opening of the plate comprises the first dial (150) described previously. The dial comprises symbols for being able to differentiate various positions. The first ring comprises an indicator, for example an arrow, on its crenellated edge that points to a symbol on the dial. Thus, a rotary position between the plate and the adjustable guide ring is indicated on said dial.

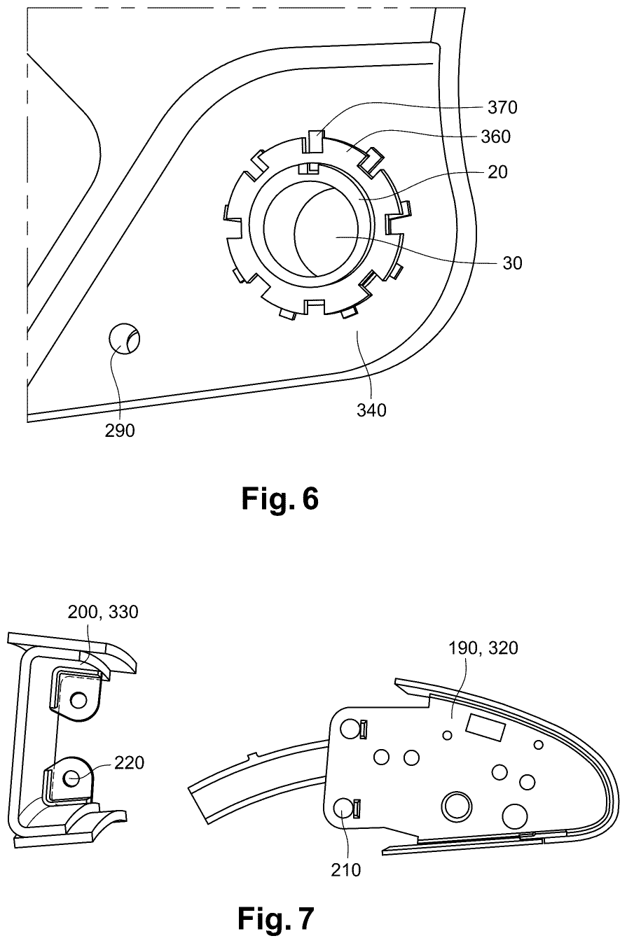

In a supplementary manner, the adjustable ring can be secured to the environment receiving the ring by a nut (360), secured by a tab washer (370), shown in FIG. 6. FIG. 6 shows the opposite side of the environment receiving the adjustable ring, shown in FIG. 3. In the example shown in FIGS. 3 and 6, the nut is secured to a screw thread on the first ring. The first ring is placed with its crenellated edge on the first ring. Thus, the nut secures the adjustable ring on the part receiving the ring. The tab washer ensures that the nut does not become unscrewed.

Advantageously, a measurement and adjustment device (hereinafter referred to as “device”) can be used to configure the adjustable guide ring together with its plate for use.

The measurement device determines the distance between centres of the piercings (FIG. 1) and the direction of said distance with respect to the position of the securing point (290) on the first or second part. Next, the measurement device provides the value to be adjusted on the dial of the first or second ring (80). In other words, a value on the dial (80) is provided that must be set facing the indicator (70), see FIG. 3. In the example shown in FIGS. 1 and 3, the measurement device would indicate adjusting the position “A” on the dial. The arrow on the first ring is thus turned to be set facing the symbol “A” on the dial of the second ring.

Next or at the same time, the measurement device provides a position to be adjusted on the second dial. In other words, a second indicator on the edge of the first ring is set facing a value of the second dial. In the example shown in FIGS. 1 and 3, the measurement device would indicate adjusting the position “2” on the second dial. The plate is thus secured with its crenellated opening on the crenellated edge of the first and second ring so that the arrow on the crenellated edge of the first ring points to the position “2” on the second dial.

The adjustable ring with its plate can next be secured to the second part, shown in FIG. 1, on the right. The first securing device (130) on the plate is secured at the securing point (290) on the second part while the adjustable ring is inserted in the second piercing (220) in the second part. Consequently, the first opening (30) of the first ring is aligned with the first piercing in the first part, and the connection bolt can be installed. The values supplied by the measurement device are determined so that the eccentricity of the adjustable ring and the direction of the eccentricity corresponds to the distance between centres (250) when the securing device of the plate (130) is secured to the securing point (290), see FIGS. 1 and 3.

Said measurement and adjustment device can be a mechanical device. It is also possible for said measurement and adjustment to be an optical device. For example, the device can comprise a camera or a three-dimensional scanner for acquiring a representation of the first piercing, of the second piercing and of the securing point (290) when the first and the second piece are held in a required relative position. Knowing the eccentricity of the first and of the second ring of the adjustable ring and a positioning of the dial and of the second dial, the device can next provide the values to be adjusted on the two dials to configure the adjustable ring for being used with the first and second part.

It is also possible for the device to implement a three-dimensional digitisation of a first portion representing the wing box to obtain a first digital model, and to implement a three-dimensional digitisation of a second portion representing the leading-edge module in order to obtain a second digital model. The first portion comprises a first reference region and the first piercing, the second portion comprising a second reference region and the second piercing. The securing point (290) is located on the first or on the second representative portion. Next, a relative position of the first reference region with respect to the second reference region is defined to locate the wing box and the leading-edge module at a required position. Consequently, the relative position of the first piercing with respect to the second piercing and the positioning of the securing point are known. The device next provides the values to be adjusted on the dials of the adjustable ring (10) to establish the connection.

Hereinafter, the procedure for adjusting the eccentricity of the adjustable ring will be described in more detail. The procedure can be implemented on a computer. It can also be implemented by a mechanical device. Hereinafter, only the expression “device” will be used for the tool implementing the method.

During a first step, the eccentricity (170) of the first ring and the eccentricity (180) of the second ring are provided to the adjustment device. It is also possible for said values to be measured by the device. As described previously, the eccentricity is the distance, for example in millimetres, between the centre of the opening of the ring and the centre of the external circumference of the ring. The eccentricity of the adjustable ring can be adjusted in a range of values, said range extending between the sum of the two eccentricities as far as the difference between the two eccentricities of the two rings forming the adjustable ring.

During a second step, the device receives or measures a distance (250) between centres of a first circular piercing (210) in a first part (190) and of a second circular piercing (220) in a second part (200) when said parts are positioned at a required relative position, as shown in FIG. 1.

During a third step, the device determines a rotary position (260) of the first ring with respect to the second ring so that the eccentricity (270) of the adjustable guide ring corresponds to said distance between centres. Said rotary position of the first ring inside the second ring can for example be determined with respect to a maximum position. Said maximum position is the one where the adjustable guide ring has maximum eccentricity. In other words, maximum position means the rotary position in which the two eccentricities of the first and of the second ring are added together. The rotary position with respect to this maximum position is indicated on FIG. 2 by the reference 260.

As described previously, the first and second ring can comprise an indicator or dial (70, 80). In this case, the device can directly provide a position to be adjusted on said dial to establish the rotary position of the first ring with respect to the second ring. In the example shown in FIG. 3, the device would indicate “A”. A user can next change the relative position of the first and second ring until the arrow on the first ring points to “A” on the dial on the second ring.

The device can also provide the necessary information for installing the second securing means and thus orient the adjustable guide ring with respect to the environment receiving the ring. This step takes place after having determined the relative rotary position of the first and of the second eccentric ring.

The device receives or determines a direction (280) of the distance between centres with respect to a point (290) of securing the second securing means on the first or second part. More precisely, the device receives or measures an angle (280) between a first straight line passing through the centres (230, 240) of the piercings in the two parts (190, 200) to be secured and a second straight line passing through the centre of the piercing receiving the adjustable ring (240) and the securing point (290) serving to secure the second securing means, as shown in FIG. 1, right-hand portion.

The device next determines and provides a rotary position (300) of the second securing means with respect to the first and/or second ring to orient the eccentricity of the guide ring in the direction determined when the second securing means is secured to the securing point. In the example shown in FIGS. 1 and 3, the rotary position provided enables a user to secure the plate at one from the several possible positions on the adjustable guide ring. Next, the plate is secured with the opening (130) on the securing point (290). Consequently, the orientation (270) of the eccentricity of the adjustable ring is aligned with the direction (250) of the distance between centres, see FIGS. 1, 3. Advantageously, the device can provide a position (310) to be adjusted on the second dial to establish said rotary position of the second securing means with respect to the first and/or second ring. In the example shown in FIG. 3, the device would provide “2” as the position to be adjusted. A user can thus position the plate to set the symbol “2” of the second dial at the position of the arrow on the first ring.

As described previously, the adjustable guide ring can advantageously be used for securing a leading-edge module (320) to a wing box (330), shown in FIG. 7. Thus, in the above description, the first part to be secured can be the leading-edge module and the second part to be secured can be the wing box. In the example shown in FIG. 3, the leading-edge module is brought close to the wing box to hold the two at a required position. Next, the adjustable guide ring is configured to be able to secure the two parts by a connection bolt passing through the first piercing (210) in the leading-edge module and the second piercing in the wing box.

1. An adjustable guide ring (10) comprising a first ring (20) with a first eccentric opening (30) and a second ring (40) with a second eccentric opening (50),
the first ring being housed in the second opening of the second ring,
the first ring and the second ring comprising an indicator (70) for indicating an orientation of the eccentricity of the first ring in the second ring.

2. The ring according to claim 1, wherein an eccentricity of the first opening in the first ring corresponds to the eccentricity of the second opening in the second ring.

3. The ring according to claim 1, comprising a first securing means (60) for fixing a relative position between the first and the second ring.

4. The ring according to claim 1, wherein the indicator comprises a dial (80) on the first and/or on the second ring, the dial comprising symbols for indicating an orientation of the eccentricity of the first ring in the second ring.

5. The ring according to claim 4, comprising a second securing means for fixing a rotary position of the first and/or of the second ring with respect to an environment (340) receiving the second ring,
the second securing means (90) being configured to be able to be secured to the first and/or the second ring at one from a plurality of rotary positions (100),
the second securing means comprising a second dial (110) for indicating said rotary position.

6. The ring according to claim 5, wherein the second securing means is a plate (120) comprising a first device (130) for being secured to the environment and a crenellated opening (140) for receiving the first ring,
the crenellated opening comprising the second dial (150),
the first ring comprising a crenellated edge (160) configured to be housed in said crenellated opening.

7. A method for adjusting an eccentricity of the ring according to claim 1, the method comprising the following steps:
providing the eccentricity (170) of the first ring and the eccentricity (180) of the second ring,
providing a distance (250) between centres of a first circular piercing (210) in a first part (190) and of a second circular piercing (220) in a second part (200) when said parts are positioned at a required relative position, and
determining a rotary position (260) of the first ring with respect to the second ring so that the eccentricity (270) of the adjustable guide ring corresponds to said distance.

8. The method according to claim 7, the indicator comprising a dial (80) on the first and/or on the second ring, the dial comprising symbols for indicating an orientation of the eccentricity of the first ring in the second ring, and said dial on the first and/or on the second ring,
the method comprising the step of providing a position to be adjusted on said dial to establish the rotary position of the first ring with respect to the second ring determined.

9. The method according to claim 8, wherein the ring further comprises a second securing means for fixing a rotary position of the first and/or of the second ring with respect to an environment (340) receiving the second ring, the second securing means (90) being configured to be able to be secured to the first and/or the second ring at one from a plurality of rotary positions (100), the second securing means comprising a second dial (110) for indicating said rotary position,
the method comprising the following steps:
determining a direction (280) of the distance between centres with respect to a point (290) of securing the second securing means on the first or second part,
determining a rotary position (300) of the second securing means with respect to the first and/or second ring to orient the eccentricity of the guide ring in the direction determined when the second securing means is secured to the securing point, preferably,
providing a position (310) to be adjusted on the second dial to establish said rotary position of the second securing means with respect to the first and/or second ring.

10. A method for securing a leading-edge module (320) on a wing box (330) comprising the following steps:
providing the ring according to claim 6, the indicator comprising a dial (80) on the first and/or on the second ring, the dial comprising symbols for indicating an orientation of the eccentricity of the first ring in the second ring, and said dial on the first and/or on the second ring, the ring further comprising a second securing means for fixing a rotary position of the first and/or of the second ring with respect to an environment (340) receiving the second ring, the second securing means (90) being configured to be able to be secured to the first and/or the second ring at one from a plurality of rotary positions (100), the second securing means comprising a second dial (110) for indicating said rotary position,
implementing a method for adjusting an eccentricity of the ring, the method comprising the following steps:
providing the eccentricity (170) of the first ring and the eccentricity (180) of the second ring,
providing a distance (250) between centres of a first circular piercing (210) in a first part (190) and of a second circular piercing (220) in a second part (200) when said parts are positioned at a required relative position,
determining a rotary position (260) of the first ring with respect to the second ring so that the eccentricity (270) of the adjustable guide ring corresponds to said distance,
providing a position to be adjusted on said dial to establish the rotary position of the first ring with respect to the second ring determined
determining a direction (280) of the distance between centres with respect to a point (290) of securing the second securing means on the first or second part,
determining a rotary position (300) of the second securing means with respect to the first and/or second ring to orient the eccentricity of the guide ring in the direction determined when the second securing means is secured to the securing point, and
providing a position (310) to be adjusted on the second dial to establish said rotary position of the second securing means with respect to the first and/or second ring.
wherein the first part is the leading-edge module and the second part is the wing box.
